(19) United States
(12) Patent Application Publication
(10) Pub. No.: US 2022/0067401 A1
(43) Pub. Date: Mar. 3, 2022

(54) ROAD OBSTACLE DETECTION DEVICE, ROAD OBSTACLE DETECTION METHOD AND PROGRAM

(71) Applicant: TOYOTA JIDOSHA KABUSHIKI KAISHA, Toyota-shi (JP)

(72) Inventors: Kenji HORIGUCHI, Tokyo (JP); Toshiaki OHGUSHI, Tokyo (JP); Masao YAMANAKA, Tokyo (JP)

(73) Assignee: TOYOTA JIDOSHA KABUSHIKI KAISHA, Toyota-shi (JP)

(21) Appl. No.: 17/348,251

(22) Filed: Jun. 15, 2021

(30) Foreign Application Priority Data
Aug. 25, 2020 (JP) 2020-142094

(51) Int. Cl. G06K 9/00; G06T 7/13; G06T 7/11

(52) U.S. Cl. CPC G06K 9/00805; G06K 9/00798; G06T 7/13; G06T 2207/30256; G06T 2207/20076; G06T 2207/20021; G06T 2207/30261; G06T 7/11

(57) ABSTRACT

In a road obstacle detection device, a first derivation unit derives, for each of a plurality of local regions, a probability that a local region is the road, such that the probability is higher as the ratio of a road region in the local region is higher; and a second derivation unit derives a probability that a target local region is not a previously decided normal physical body, and derives a probability that a road obstacle exists at the target local region, based on the derived probability that the target local region is not the normal physical body and a probability that a peripheral local region is the road, the peripheral local region being a local region at a periphery of the target local region, the probability that the peripheral local region is the road being derived by the first derivation unit.

### CROSS-REFERENCE TO RELATED APPLICATION

This application claims priority to Japanese Patent Application No. 2020-142094 filed on Aug. 25, 2020, incorporated herein by reference in its entirety.

### BACKGROUND

### 1. Technical Field

The present disclosure relates to a technology for detecting a road obstacle based on an image resulting from photographing a road.

### 2. Description of Related Art

Japanese Unexamined Patent Application Publication No. 2018-194912 (JP 2018-194912 A) discloses a road obstacle detection device that divides an image photographed by an in-vehicle camera into a plurality of local regions, and that calculates the probability that a road obstacle exists at a target local region, based on the probability that the target local region is not a normal physical body and a visual conspicuity. The visual conspicuity is calculated such that the visual conspicuity is higher as the probability that a peripheral local region is a road is higher and as difference in visual feature between the target local region and the peripheral local region is larger. The probability that the target local region is not the normal physical body is an average of the probability that the semantical label of a pixel in the region is other than the normal physical body. The probability that the peripheral local region is the road is an average of the probability that the semantical label of a pixel in the region is the road.

### SUMMARY

In the technology in JP 2018-194912 A, in an image in which a part of the road is hidden by a forward vehicle, the probability that a local region in the forward vehicle is the road is close to zero. Therefore, even when a road obstacle exists at a target local region adjacent to the forward vehicle, the probability that the road obstacle exists at the target local region is calculated so as to be low, because the probability that the peripheral local region that is the local region in the forward vehicle is the road is low. As a result, it is hard to detect the road obstacle.

The present disclosure has been made in view of the circumstance, and an object of the present disclosure is to provide a technology that can improve detection accuracy when detecting the road obstacle based on the image resulting from photographing the road.

For solving the above problem, a road obstacle detection device according to an aspect of the present disclosure includes: an acquisition unit configured to acquire an image resulting from photographing a road; a detection unit configured to detect roadway edge lines from the acquired image; a road region estimation unit configured to estimate a road region in the image, based on the detected roadway edge lines; a division unit configured to divide the acquired image into a plurality of local regions; a first derivation unit configured to derive, for each of the plurality of local regions, a probability that the local region is the road, such that the probability is higher as the ratio of the road region in the local region is higher; and a second derivation unit configured to derive a probability that a target local region is not a previously decided normal physical body, and to derive a probability that a road obstacle exists at the target local region, based on the derived probability that the target local region is not the normal physical body and a probability that a peripheral local region is the road, the peripheral local region being a local region at a periphery of the target local region, the probability that the peripheral local region is the road being derived by the first derivation unit.

Another aspect of the present disclosure is a road obstacle detection method. The method includes: an acquisition step of acquiring an image resulting from photographing a road; a detection step of detecting roadway edge lines from the image acquired in the acquisition step; an estimation step of estimating a road region in the image, based on the roadway edge lines detected in the detection step; a division step of dividing the image acquired in the acquisition step, into a plurality of local regions; a first derivation step of deriving, for each of the plurality of local regions, a probability that the local region is the road, such that the probability is higher as the ratio of the road region in the local region is higher; and a second derivation step of deriving a probability that a target local region is not a previously decided normal physical body, and deriving a probability that a road obstacle exists at the target local region, based on the derived probability that the target local region is not the normal physical body and a probability that a peripheral local region is the road, the peripheral local region being a local region at a periphery of the target local region, the probability that the peripheral local region is the road being derived in the first derivation step.

With the present disclosure, it is possible to improve detection accuracy when detecting the road obstacle based on the image resulting from photographing the road.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram of a road obstacle detection device in a first embodiment;

FIG. 2 is a diagram showing an example of an image that is input to an acquisition unit in FIG. 1;

FIG. 3 is a diagram showing approximate straight lines detected from the image in FIG. 2;

FIG. 4 is a diagram for describing a result of a local region division and a distance between local regions;

FIG. 5 is a diagram showing a processing result by a semantical label estimation unit;

FIG. 6 is a diagram showing an example of a derivation result of a road obstacle possibility by a likelihood derivation unit;

FIG. 7 is a diagram showing a result of a threshold process to the road obstacle possibility;

FIG. 8 is a diagram showing another image that is input to the acquisition unit;

FIG. 9 is a flowchart showing a process in the road obstacle detection device in FIG. 1;

FIG. 10 is a diagram showing an example of an image that is input to the acquisition unit in FIG. 1 according to a second embodiment;

FIG. 11 is a diagram showing an example of an image of second lines that are obtained by superimposing first lines detected from each of a plurality of images including the image in FIG. 10;

FIG. 12 is a diagram showing an example of an image that is input to the acquisition unit in FIG. 1 according to a third embodiment;

FIG. 13 is a diagram showing an image of second lines that are obtained by superimposing first lines detected from each of a plurality of images including the image in FIG. 12;

FIG. 14 is a diagram showing an image resulting from superposing approximate curve lines in FIG. 13 on the image in FIG. 12;

FIG. 15 is a diagram showing an image resulting from superposing approximate curve lines in a comparative example on the image of the second lines in FIG. 13; and

FIG. 16 is a diagram showing an image resulting from superposing approximate curve lines in FIG. 15 on the image in FIG. 12.

### DETAILED DESCRIPTION OF EMBODIMENTS

In embodiments, a road obstacle is detected based on one still image photographed by a camera that is mounted on a vehicle. In the embodiments, a technique in which learning about obstacles is not performed is employed. Therefore, it is possible to accurately detect even an unknown obstacle.

### First Embodiment

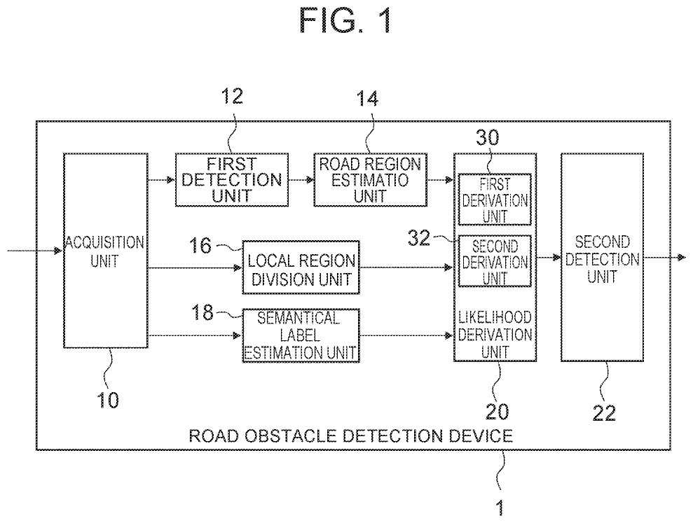

FIG. 1 is a block diagram of a road obstacle detection device 1 in a first embodiment. The road obstacle detection device 1 includes an acquisition unit 10, a first detection unit 12, a road region estimation unit 14, a local region division unit 16, a semantical label estimation unit 18, a likelihood derivation unit 20, and a second detection unit 22. The likelihood derivation unit 20 includes a first derivation unit 30 and a second derivation unit 32.

The configuration of the road obstacle detection device 1 can be realized by a CPU, a memory and other LSIs of an arbitrary computer, in terms of hardware, and can be realized by programs loaded on the memory, and the like, in terms of software. FIG. 1 illustrates functional blocks that are realized by cooperation of hardware and software. Accordingly, those skilled in the art understand that these functional blocks are realized in various ways such as only hardware, only software and a combination of hardware and software.

The acquisition unit 10 acquires an image that is input from the exterior of the road obstacle detection device 1, and outputs an image I(t) at time t to the first detection unit 12, the local region division unit 16 and the semantical label estimation unit 18. This image is an image resulting from photographing a road located forward of the vehicle using a camera mounted on the vehicle. The acquisition unit 10 may directly acquire the image from the camera, or may acquire the image by communication.

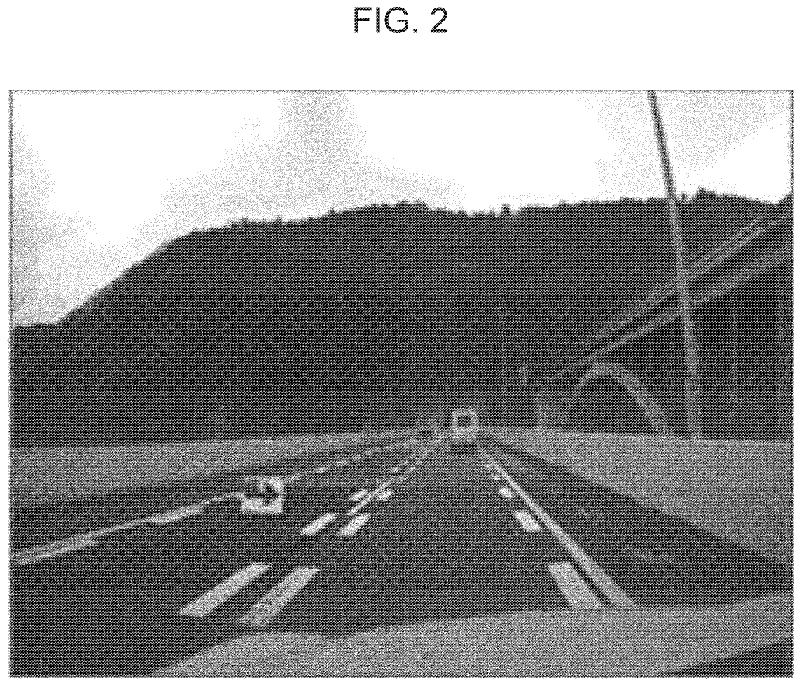

FIG. 2 shows an example of the image I(t) that is input to the acquisition unit 10 in FIG. 1. It is preferable that the image be a color image from a standpoint of detection accuracy, but the image may be a monochrome image.

The first detection unit 12 detects two roadway edge lines from the acquired image. Each of the roadway edge lines indicates a border between a roadway and a side strip. Specifically, the first detection unit 12 detects a plurality of lines from the acquired image, evaluates approximate lines of lines that are of the plurality of detected lines and that have lengths equal to or longer than a predetermined value, and detects approximate lines that are of the evaluated approximate lines and that have the largest and smallest slopes, as the roadway edge lines. The line to be detected includes a white line and a yellow line on the road, for example. The line can be detected using a known technology such as template matching. On that occasion, the first detection unit 12 may limit candidates of lines by performing binarization of edge strength on the image based on luminance gradient between the line and the road. Further, the first detection unit 12 may detect, as the lines, regions for which semantical labels such as “white line” and “yellow line” are estimated by the semantical label estimation unit 18 described later.

The approximate line may be an approximate straight line, or may be an approximate curve line. The approximate straight line can be evaluated, for example, by executing Hough transform to the line. The approximate curve line may be a second-order or higher-order curve line, and can be evaluated, for example, by executing a known curve fitting to the line. In the case of the approximate curve line, the first detection unit 12 may detect approximate curve lines that have the largest and smallest slopes, based on slopes in ranges of overlaps with lines. By using the approximate curve line, it is possible to estimate a road region with a high accuracy on not only a straight road but also a curve road.

For example, a plurality of diagonal lines of a zebra zone on the road is also detected as the line. When the diagonal lines are falsely detected as the roadway edge line, the road region is falsely estimated. Lines having lengths shorter than the predetermined value, which are unlikely to be roadway edge lines, are excluded. Therefore, it is possible to restrain the false detection of the roadway edge line. The predetermined value can be appropriately set based on an experiment or a simulation.

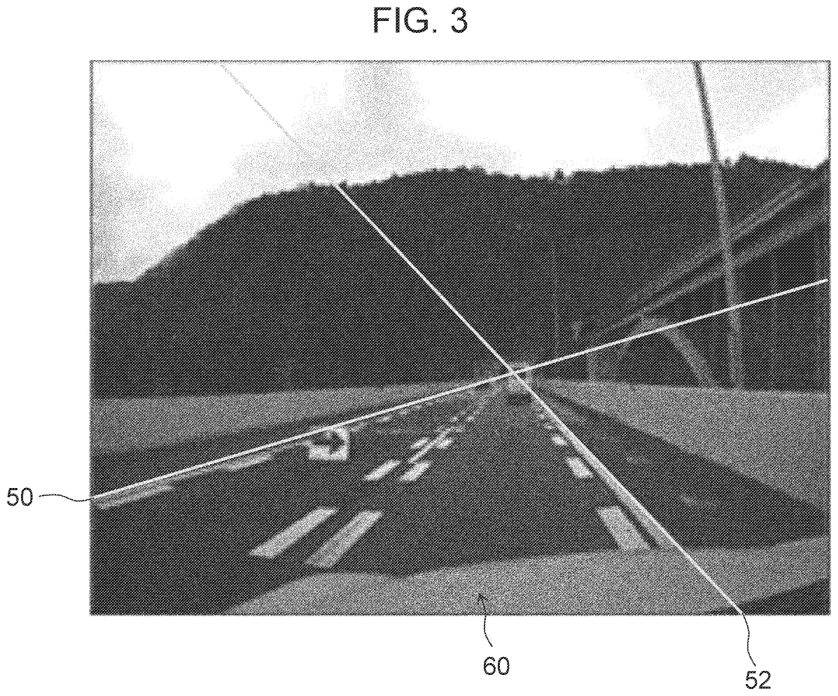

FIG. 3 shows approximate straight lines detected from the image in FIG. 2. An approximate straight line 50 and an approximate straight line 52 showing the roadway edge lines are detected.

The road region estimation unit 14 estimates the road region in the image based on the roadway edge lines detected by the first detection unit 12, and outputs information about the estimated road region, to the likelihood derivation unit 20. The road region estimation unit 14 estimates that the road region is a region that is on a lower side in the image and that is partitioned by the two detected roadway edge lines. In the image, a photographing position side is referred to as the lower side. In the example of FIG. 3, it is estimated that the road region is a polygonal road region 60 that is partitioned by the approximate straight line 50 and the approximate straight line 52.

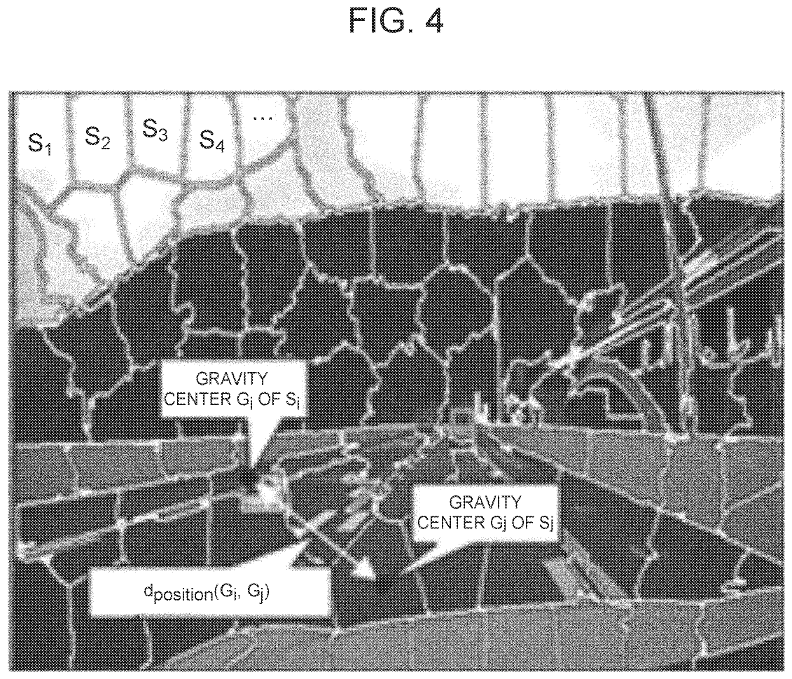

FIG. 4 is a diagram for describing a result of a local region division and a distance between local regions. As shown in FIG. 4, the local region division unit 16 divides the image I(t) into N local regions Sₙ (n=1, . . . , N). The division process is also referred to as a super-pixelation process. Each local region is a continuous region and is a region in which the feature quantities of the points in the interior are similar to each other. As the feature quantity, color, luminance, edge strength, texture or the like can be used. The local region can be expressed as a region that does not contain the border between a foreground and a background. As a local region division algorithm, a known algorithm can be used. The local region division unit 16 outputs the N local region Sₙ after the division, to the likelihood derivation unit 20.

The semantical label estimation unit 18 estimates the semantical label for each pixel p(x, y) of the image I(t). The semantical label estimation unit 18, which has performed learning for a discriminator to discriminate a plurality of kinds (M kinds) of physical bodies in advance, calculates, for each pixel p(x, y), a probability Pₘ (m=1, . . . , M) that the pixel p(x, y) belongs to a semantical label Lₘ (m=1, . . . , M), and outputs the probability Pₘ to the likelihood derivation unit 20.

The physical body that is learned by the semantical label estimation unit 18 includes the sky, roads (paved roads, white lines and the like), vehicles (passenger cars, trucks, motorcycles and the like), nature (mountains, forests, street trees and the like), and artificial architectures (street lamps, iron poles, guardrails and the like). The semantical label estimation unit 18 learns only normal physical bodies, that is, only physical bodies other than obstacles, and does not need to learn obstacles. The semantical label estimation unit 18 may learn representative obstacles. When learning data is prepared, an “unknown” label or an “others” label is put to a physical body for which the right answer (ground truth) is unclear. In that sense, unknown physical bodies, that is, obstacles are also learned.

The estimation of the semantical label can be realized using an arbitrary known algorithm. For example, a conditional random field (CRF) based technique, a deep learning (particularly, convolutional neural network (CNN)) based technique, a technique in which the CRF and the deep learning are combined, and the like can be employed.

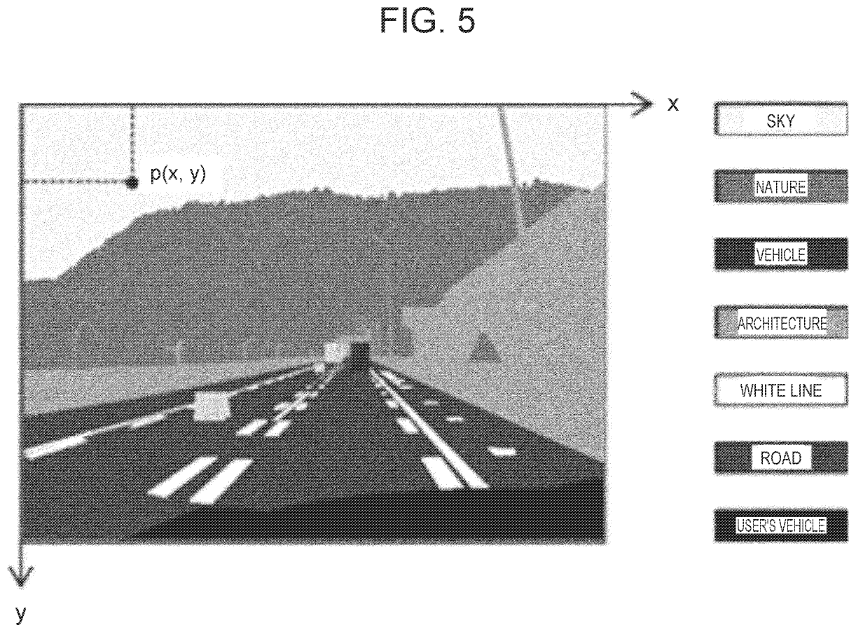

FIG. 5 shows a processing result by the semantical label estimation unit 18. As described above, the probability is evaluated for each pixel p(x, y) and for each semantical label Lₘ, but FIG. 5 shows a semantical label having the highest probability, for each pixel.

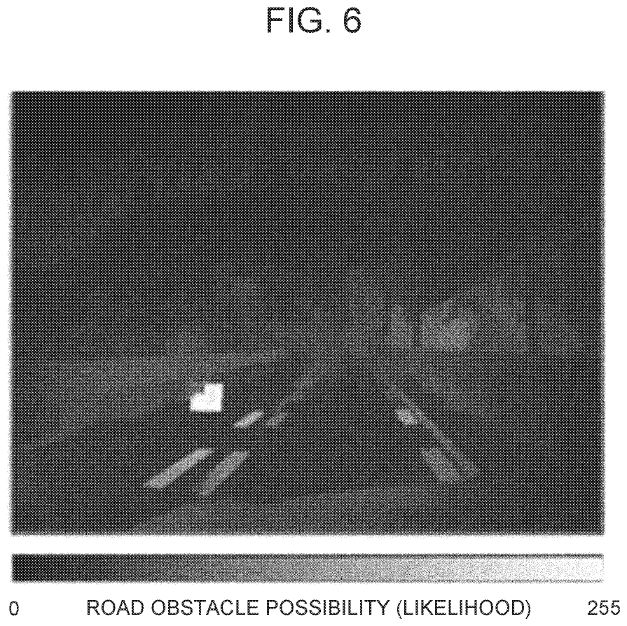

As shown in FIG. 6, the likelihood derivation unit 20 calculates a road obstacle possibility Lᵢ (likelihood) at an i-th (i=1, . . . , N) local region Sᵢ of the image I(t), based on the road region estimated by the road region estimation unit 14, the local region Sₙ (n=1, . . . , N) obtained by the local region division unit 16, and the probability Pₘ (m=1, . . . , M) obtained by the semantical label estimation unit 18, and outputs the road obstacle possibility Lᵢ to the second detection unit 22. Specifically, the road obstacle possibility Lᵢ is defined as Expression (1).

$$\begin{matrix}[ Expression 1 ] & \\ {L}_{i} = {\sum }_{j = 1}^{N} \{ n ( {S}_{j} ) \cdot {d}_{appear} ( {S}_{i} , {S}_{j} ) \cdot {P}_{road} ( {S}_{j} ) \cdot W ( {d}_{position} ( {S}_{i} , {S}_{j} ) ) \} \cdot {P}_{others} ( {S}_{i} ) & Expression ( 1 )\end{matrix}$$

Here, each member of Expression (1) has the following meaning.

First, n(Sⱼ) represents the size of a j-th (j=1, . . . , N) local region Sⱼ. As n(Sⱼ), for example, the number of the pixels in the local region Sⱼ can be employed.

Further, dₐₚₚₑₐᵣ(Sᵢ, Sⱼ) represents a visual difference degree between the i-th local region Sᵢ and the j-th local region Sⱼ, that is, a difference degree (distance) of appearance (visual effect). The evaluation of the appearance may be performed based on color, luminance, edge strength, texture or the like. In the case where the visual difference degree is evaluated using the difference degree of the color feature, dₐₚₚₑₐᵣ(Sᵢ, Sⱼ) may be evaluated as the Euclidean distance between an average (Hᵢ, Sᵢ, Vᵢ) of the color feature in the local region Sᵢ and an average (Hⱼ, Sⱼ, Vⱼ) of the color feature in the local region Sⱼ. The same goes for the case where an appearance feature other than color is used. Further, the visual difference degree may be evaluated by comprehensively considering a plurality of appearance features.

In the case where at least a part of the local region Sⱼ overlaps with the road region estimated by the road region estimation unit 14 and where the semantical label of the local region Sⱼ is the “vehicle”, dₐₚₚₑₐᵣ(Sᵢ, Sⱼ) may be derived while the feature quantity is replaced by the feature quantity of a local region for which the semantical label is the “road”. Even in the case of such a replacement, the difference between the feature quantity of the “physical body other than the normal physical body” that needs to be detected as the road obstacle and the feature quantity of the “road” is relatively large, and therefore the visual difference degree is relatively large. Whether to replace the feature quantity may be previously decided by an experiment or a simulation, such that the detection accuracy of the road obstacle increases.

Further, P_{road}(Sⱼ) represents the probability that the j-th local region Sⱼ is the “road”. The derivation method for P_{road}(Sⱼ) differs depending on whether the local region Sⱼ overlaps with the road region.

In the case where at least a part of the local region Sⱼ overlaps with the road region, the first derivation unit 30 derives the probability P_{road}(Sⱼ) that the local region Sⱼ is the road, such that the probability P_{road}(Sⱼ) is higher as the ratio of the road region in the local region Sⱼ is higher. For example, the ratio of the road region in the local region Sⱼ may be expressed in percentage, and may be adopted as P_{road}(Sⱼ). Local regions to be targeted are all local regions regardless of the semantical label. That is, even when the local region is not the road in reality, the probability P_{road}(Sⱼ) that the local region is the road increases if the local region is in the road region. In this way, for an arbitrary local region that overlaps with the road region, as exemplified by the “vehicle” and the “physical body other than the normal physical body”, the probability P_{road}(Sⱼ) that the local region is the road increases.

The ratio of the road region in the local region can be evaluated by various known methods. For example, by an intersection number determination, it may be determined whether the pixel is in the road region for each pixel in the local region. The logical product between a binary image of the road region and a binary image of the local region may be evaluated, and the number of pixels for which the result of the logical product is 1 may be adopted as the number of the pixels of the road region in the local region.

In the case where the local region Sⱼ does not overlap with the road region, the first derivation unit 30 derives the probability P_{road}(Sⱼ) that the local region Sⱼ is the road, as an average of the probability that the semantical label of the pixel in the local region Sⱼ is the “road”. In the case where the “road” is constituted by the “paved road” and the “white line”, the probability that the semantical label is the “road” is the probability that the semantical label is the “paved road” or the “white line”. Thereby, it is possible to increase the probability that the local region of the side strip on the outside of the roadway edge line is the road, and therefore it is possible to detect also the road obstacle on the side strip.

Further, dₚₒₛᵢₜᵢₒₙ(Sᵢ, Sⱼ) represents the distance between the local region Sᵢ and the local region Sⱼ. For example, the distance between the local regions may be defined by an inter-gravity-center distance. That is, dₚₒₛᵢₜᵢₒₙ(Sᵢ, Sⱼ) may be evaluated as the Euclidean distance (see FIG. 4) between a gravity center position Gᵢ of the local region Sᵢ and a gravity center position Gⱼ of the local region Sⱼ. From this standpoint, dₚₒₛᵢₜᵢₒₙ(Sᵢ, Sⱼ) may be expressed as dₚₒₛᵢₜᵢₒₙ(Gᵢ, Gⱼ).

Further, W(dₚₒₛᵢₜᵢₒₙ(Gᵢ, Gⱼ)) is a function that represents a weight depending on the inter-gravity-center distance dₚₒₛᵢₜᵢₒₙ between the local regions Sᵢ, Sⱼ. The function W may have any form if the function W is smaller as the inter-gravity-center distance dₚₒₛᵢₜᵢₒₙ is larger. For example, a Gaussian weight function shown by Expression (2) can be employed. Here, w₀ represents a median of the gravity center distances of all local region pairs.

$$\begin{matrix}[ Expression 2 ] & \\ W ( {d}_{position} ( {G}_{i} , {G}_{j} ) ) = exp ( - \frac{{{d}_{position} ( {G}_{i} , {G}_{j} )}^{2}}{2 \cdot {w}_{0}^{2}} ) & Expression ( 2 )\end{matrix}$$

Further, Pₒₜₕₑᵣₛ(Sᵢ) is the probability that the semantical label of the local region Sᵢ is the physical body other than the normal physical body. In the case where the learning is performed while the learning object does not include the obstacle, “the semantical label is the physical body other than the normal physical body” means “the semantical label is the ‘others’”. In the case where the learning is performed while the learning object includes the obstacle, “the semantical label is the physical body other than the normal physical body” means “the semantical label is the ‘obstacle’ or the ‘others’”. Since the probability of the semantical label is evaluated for each pixel, Pₒₜₕₑᵣₛ may be evaluated as an average of the probability of the pixel in the local region Sᵢ, similarly to P_{road}.

In Expression (1), summation is performed in a range of j=1 to j=N. However, at j=i, dₐₚₚₑₐᵣ(Sᵢ, Sⱼ)=0 is satisfied, and therefore j=i may be excluded. Further, j at which the weight W is sufficiently close to zero may be excluded.

These processes correspond to the second derivation unit 32 deriving the probability that the target local region is not the previous decided normal physical body, based on the probability Pₘ obtained by the semantical label estimation unit 18, and deriving the probability that the road obstacle exists at the target local region, based on the derived probability that the target local region is not the normal physical body and the probability that the peripheral local region at the periphery of the target local region is the road, which is the probability derived by the first derivation unit 30. Specifically, the second derivation unit 32 derives the probability that the road obstacle exists at the target local region, based on the probability that the target local region is not the previous decided normal physical body and a visual conspicuity defined by the relation between the peripheral local region and the target local region. The visual conspicuity is derived such that the visual conspicuity is higher as the probability that the peripheral local region is the road is higher and as the difference in visual feature between the target local region and the peripheral local region is larger. The visual conspicuity is derived such that the visual conspicuity is higher as the size of the peripheral local region is larger. The visual conspicuity is derived such that the visual conspicuity is higher as the distance between the target local region and the peripheral local region is shorter.

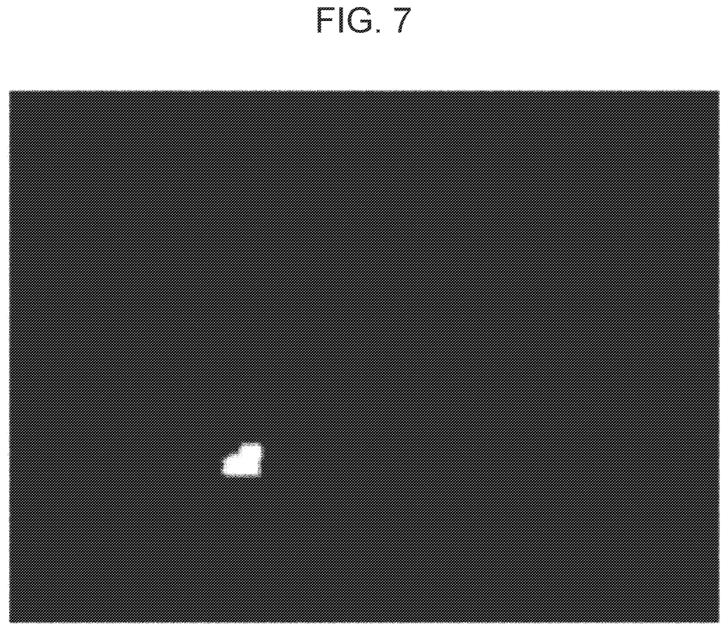

FIG. 6 shows an example of a derivation result of the road obstacle possibility Lᵢ by the likelihood derivation unit 20. FIG. 7 shows a result of a threshold process to the road obstacle possibility.

As shown in FIG. 7, the second detection unit 22 detects the road obstacle in the image I(t), based on the road obstacle possibility Lᵢ (i=1, . . . , N) obtained by the likelihood derivation unit 20. Specifically, by binarization processing, the second detection unit 22 separates the pixels in the image I(t) into a candidate region (a white region in FIG. 7) for the road obstacle and a region (a black region in FIG. 7) other than the candidate region. The threshold for the binarization processing may be a previously decided value, or may be adaptively decided such that an in-class variance is minimized and an inter-class variance is maximized. Furthermore, the second detection unit 22 sets a rectangular region circumscribed around the obtained candidate region as the attractive region, and thereby detects the road obstacle in the final image I(t).

The road obstacle detection result obtained in this way can be used in various ways. For example, a notice may be given to a driving assistance system of a vehicle on which the road obstacle detection device 1 is mounted, and a warning may be given to a driver or an avoidance control may be executed or assisted. Alternatively, the detection result may be transmitted to a rearward vehicle by a direct communication between the vehicles or by a communication via a cloud. Further, in the case where the road obstacle detection device 1 is mounted on a roadside unit, the detection result may be transmitted from the roadside unit to surrounding vehicles.

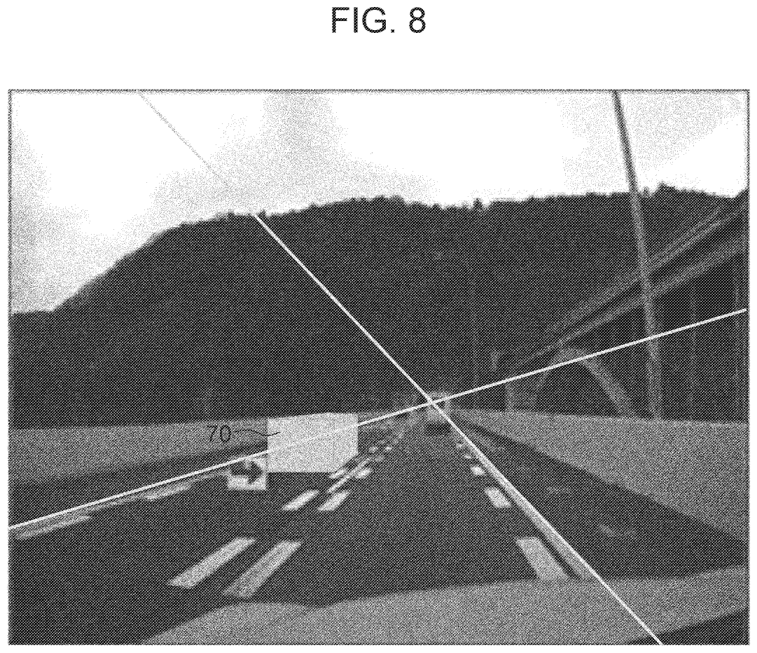

FIG. 8 shows an example of another image that is input to the acquisition unit 10. In FIG. 8, a vehicle 70 adjacent to the road obstacle exists in the image in FIG. 2. In the illustrated example, it is assumed that the vehicle 70 is in the stop state. However, the vehicle 70 adjacent to the road obstacle may be traveling on the forward side or forward lateral side of the vehicle on which the camera is mounted. In the case of traveling, the image in FIG. 8 may be an image at the timing when the road obstacle hidden by the forward vehicle appears.

As described above, in the comparative example in which the probability that the local region is the road is the average of the probability that the semantical label of the pixel in the local region is the road for all local region, the probability that the local region in the forward vehicle 70 is the road is nearly zero. Therefore, the probability that the road obstacle exists at the target local region is lower than that in the embodiment, and it is hard to detect the road obstacle.

On the other hand, in the embodiment, in the case where the road obstacle exists at the target local region adjacent to the vehicle 70 on the road, the probability that the peripheral local region that is the local region in the vehicle 70 is the road is higher than that in the comparative example. Therefore, the probability that the road obstacle exists at the target local region is higher than that in the comparative example, and it is easy to detect the road obstacle.

Further, although not illustrated, in an image in which a plurality of road obstacles such as a plurality of cones for construction adjacently exists on the road, it is assumed that the local region is generated for each road obstacle. In this case, in the comparative example, the probability that the local region for the road obstacle that is the peripheral local region is the road is nearly zero. Therefore, the probability that the road obstacle exists at the target local region is lower than that in the embodiment, and it is hard to detect the road obstacle.

On the other hand, in the embodiment, the probability that the local region for the road obstacle is the road is about 100%, and therefore the probability that the road obstacle exists at the local region of each of the plurality of road obstacles can be increased compared to the comparative example. Consequently, it is possible to increase the accuracy of the detection of the plurality of adjacent road obstacles.

Furthermore, at the vicinity of a vanishing point of the road in the image that is far from the camera, the image is prone to be unsharp compared to the vicinity of the camera. Further, the size of the local region in the image does not greatly differ, and is relatively uniform. Therefore, a local region containing the road and a portion other than the road, as exemplified by the vehicle, is prone to be generated at the vicinity of the vanishing point of the road in the image. As a result, in the comparative example, the probability that the local region at the vicinity of the vanishing point is the road is lower than the probability that the local region for the road on the side of the camera is the road. Therefore, in a situation in which the road obstacle adjacently exists on the near side of the local region at the vicinity of the vanishing point (not illustrated), it is hard to detect the road obstacle.

On the other hand, in the embodiment, in the case where the road obstacle exists at the target local region adjacent to the local region at the vicinity of the vanishing point, the probability that the peripheral local region that is the local region at the vicinity of the vanishing point is the road is increased compared to the comparative example. Therefore, the probability that the road obstacle exists at the target local region is increased, and it is easy to detect the road obstacle.

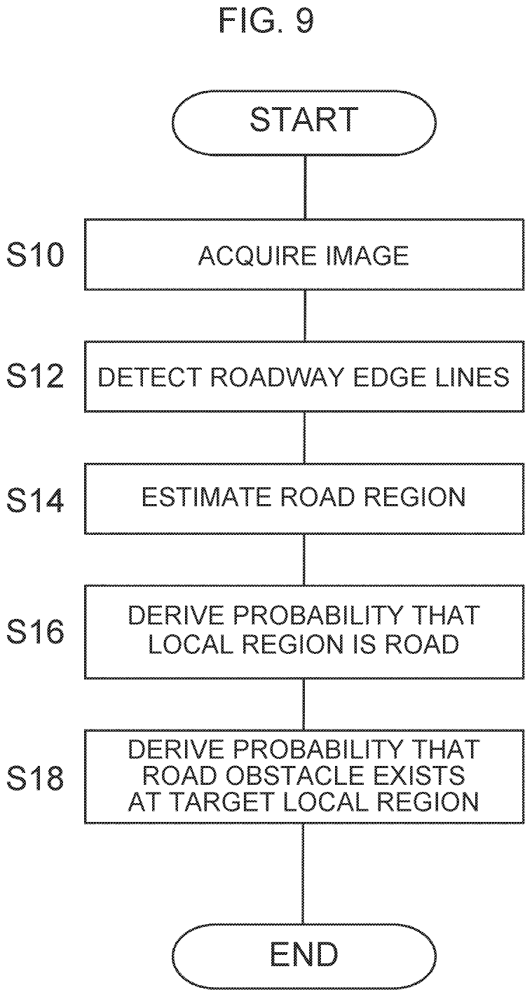

FIG. 9 is a flowchart showing a process in the road obstacle detection device 1 in FIG. 1. The acquisition unit 10 acquires the image resulting from photographing the road (S10). The first detection unit 12 detects the roadway edge lines from the acquired image (S12). The road region estimation unit 14 estimates the road region in the image, based on the detected roadway edge lines (S14). The first derivation unit 30 derives, for each local region, the probability that the local region is the road, based on the estimated road region (S16). The second derivation unit 32 derives the probability that the road obstacle exists at the target local region, based on the probability that the target local region is not the previously decided normal physical body and the probability that the peripheral local region is the road (S18).

With the embodiment, when the road obstacle is detected based on the image resulting from photographing the road, it is possible to improve the detection accuracy, even in a situation in which the road obstacle exists so as to be adjacent to the vehicle in the image.

Further, it is possible to detect the road obstacle from the image with a high accuracy, without previously learning individual road obstacles. In the method in which road obstacles are previously learned, it is not possible to detect an obstacle that has not been learned. However, in the embodiment, it is not necessary to previously learn road obstacles, and accordingly, it is possible to detect an arbitrary road obstacle.

### Second Embodiment

A second embodiment is different from the first embodiment in that the roadway edge lines are detected based on a plurality of frame images. The difference from the first embodiment will be mainly described below.

The acquisition unit 10 acquires a plurality of time-series frame images including the image I(t) and a plurality of images photographed immediately before the image I(t), and outputs the plurality of acquired images to the first detection unit 12.

The first detection unit 12 detects first lines on the road from each of the plurality of images output from the acquisition unit 10, and detects the roadway edge lines based on second lines obtained by superimposing the detected first lines. The number of images from which the first lines are detected can be appropriately decided based on an experiment or a simulation, and may be the number of frames for one second, for example. Specifically, the first detection unit 12 generates a binarized image that separately includes the detected first lines and a region other than the first lines, for each of the acquired images, and superimposes the first lines in the respective binarized images by superimposing the binarized images obtained from the plurality of images. The first detection unit 12 evaluates approximate lines of second lines that are of the plurality of second lines and that have lengths equal to or longer than a predetermined value, and detects approximate lines that are of the evaluated approximate lines and that have the largest and smallest slopes, as the roadway edge lines.

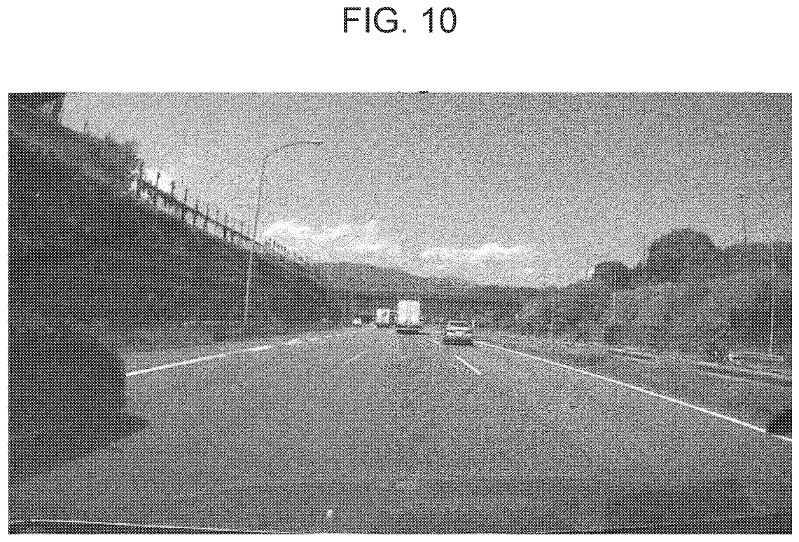

FIG. 10 shows an example of the image I(t) that is input to the acquisition unit 10 in FIG. 1 according to the second embodiment. FIG. 11 shows an example of the image of the second lines that are obtained by superimposing the first lines detected from each of a plurality of images including the image in FIG. 10.

In the case where broken lines such as lane lines on the road exist as shown in FIG. 10, it is possible to change the broken lines to solid lines as shown in FIG. 11. Further, in the case where another vehicle overlaps with the roadway edge line in the image as shown in FIG. 10, it is possible to elongate the roadway edge line by superimposing lines detected from a plurality of frame image, if the speed of the other vehicle is different from the speed of the vehicle on which the camera is mounted, although not illustrated. That is, in the case where a part of a line is hidden by a vehicle or the like in the current frame image, it is possible to increase the possibility that information about the line at the hidden part is obtained, by using other frame images. Therefore, it is easy to detect the roadway edge lines with a high accuracy.

The first detection unit 12 may superimpose the binarized image one by one, from the image I(t) that is of the plurality of images and that has the latest photographing time, in photographing time descending order, may stop the superimposition when the number of second lines obtained by the superimposition of a certain binarized image becomes larger than that before the superimposition of the certain binarized image, and may detect the roadway edge lines based on the second lines obtained before the superimposition of the certain binarized image. In the case where the vehicle on which the camera is mounted performs lane change, the positions and angles of the first lines in the image change, and therefore the number of the second lines obtained by the superimposition can increase. It is possible to superimpose the lines while excluding images photographed before the lane change and images photographed during the lane change, and therefore it is possible to detect the roadway edge lines with a high accuracy.

### Third Embodiment

A third embodiment is different from the second embodiment in that one approximate curve line is evaluated from two lines that can be regarded as one line. The difference from the second embodiment will be mainly described below.

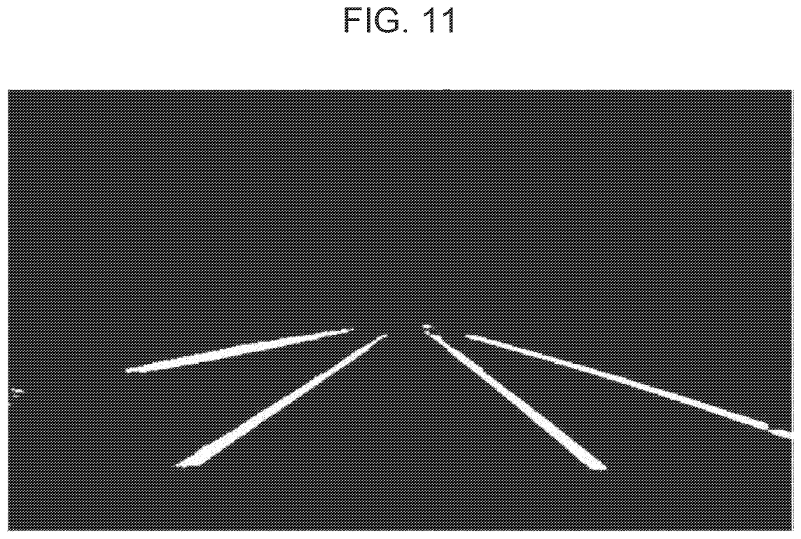

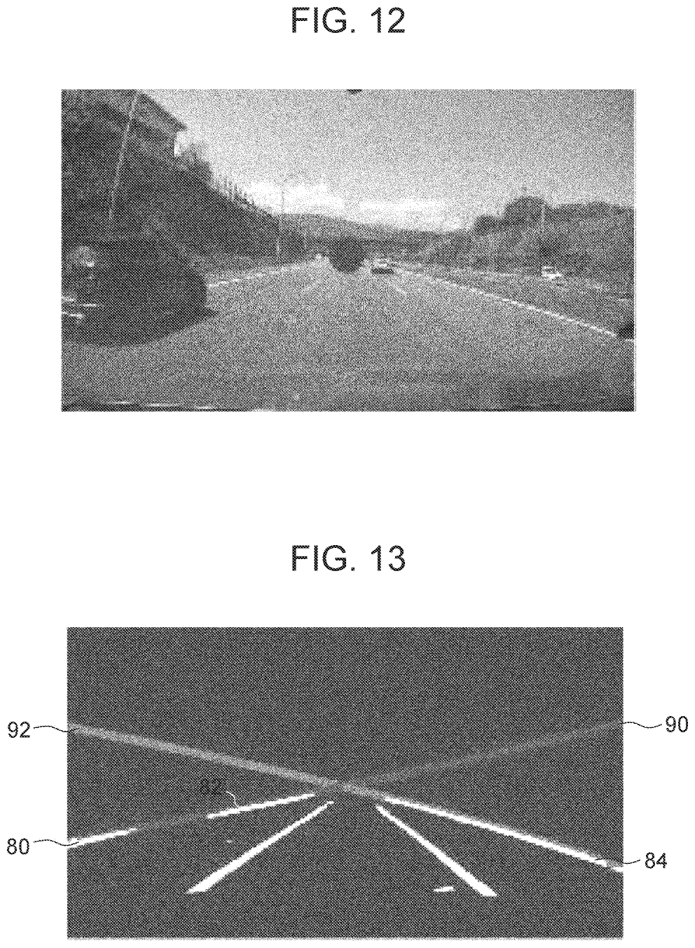

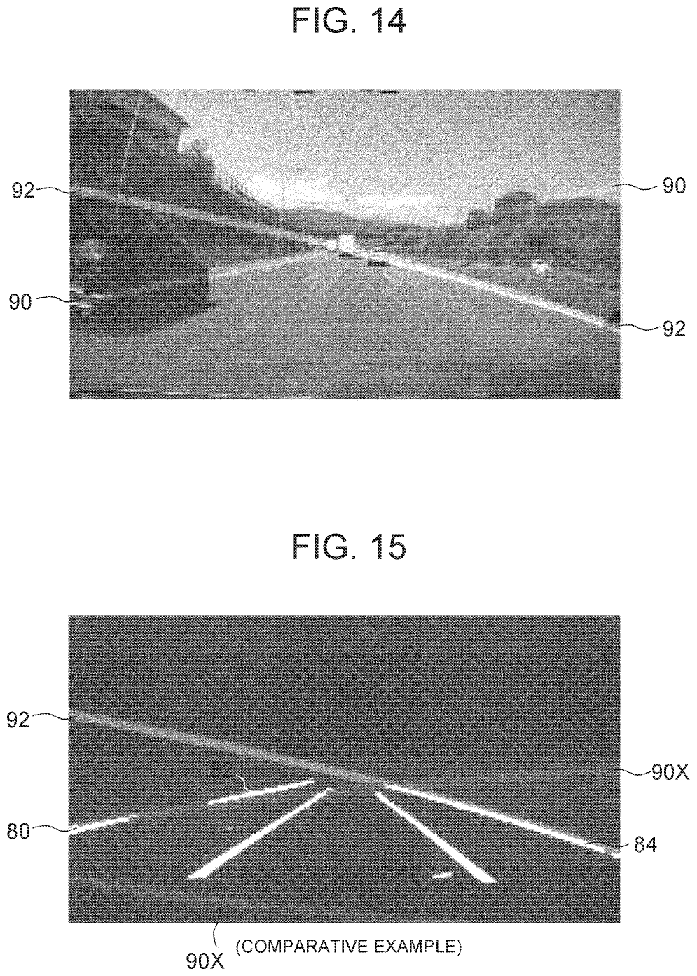

FIG. 12 shows an example of the image I(t) that is input to the acquisition unit 10 in FIG. 1 according to the third embodiment. FIG. 13 shows an image of second lines that are obtained by superimposing first lines detected from each of a plurality of images including the image in FIG. 12. FIG. 13 shows also approximate curve lines of the second lines. FIG. 14 shows an image resulting from superposing the approximate curve lines in FIG. 13 on the image in FIG. 12.

The first detection unit 12 evaluates approximate straight lines of the plurality of second lines, regardless of the lengths of the second lines, and derives the intercepts and slopes of the approximate straight lines. In the case where the slopes and intercepts of two appropriate straight lines of the plurality of appropriate straight lines satisfy a predetermined condition, the first detection unit 12 regards two second lines giving the two approximate straight lines, as one line, and evaluates one approximate curve line based on the two second lines. Specifically, the first detection unit 12 performs the fitting of an approximate curve line to the two second lines. For example, the approximate curve line is a third-order curve line. The predetermined condition is a condition that the difference in slope between the two approximate straight lines is equal to or less than a first threshold and the difference in intercept between the two approximate straight lines is equal to or less than a second threshold. The first threshold and the second threshold can be appropriately set based on an experiment or a simulation. The two second lines satisfying the predetermined condition can be regarded as an identical line on which a part is cut. The reason why approximate straight lines are used for determining whether the predetermined condition is satisfied is that the determination accuracy increases compared to the case where approximate curve lines are used.

Evaluating the approximate curve line based on the two second lines satisfying the predetermined condition can be regarded as connecting the two second lines and evaluating the approximate curve line based on the connected lines.

In FIG. 13, the approximate straight lines (not illustrated) of the second line 80 and the second line 82 satisfy the predetermined condition, and therefore the fitting of one approximate curve line 90 is performed to the second line 80 and the second line 82.

The first detection unit 12 evaluates approximate curve lines of second lines that give approximate straight lines not satisfying the predetermined condition and that have lengths equal to or longer than a predetermined value. Second lines that are of the second lines giving approximate straight lines not satisfying the predetermined condition and that have lengths shorter than the predetermined value are excluded from the object of the evaluation of the approximate curve line. Short lines often causes an inexact calculation of the approximate curve line, and therefore decreases the estimation accuracy for the road region. However, in the embodiment, it is possible to restrain the decrease in the estimation accuracy.

In FIG. 13, the fitting of the approximate curve line 92 is performed to the second line 84. The fitting of the approximate curve line may be performed also to the remaining two second lines, although not illustrated.

The first detection unit 12 detects approximate curve lines that are of the plurality of evaluated approximate curve lines and that have the largest and smallest slopes at parts overlapping with the second lines, as the roadway edge lines. In FIG. 13, the appropriate curve line 90 and the approximate curve line 92 are detected as the roadway edge lines. As seen from FIG. 13 and FIG. 14, the approximate curve line 90 coincides with the actual roadway edge line with a high accuracy.

Here, a comparative example will be described.

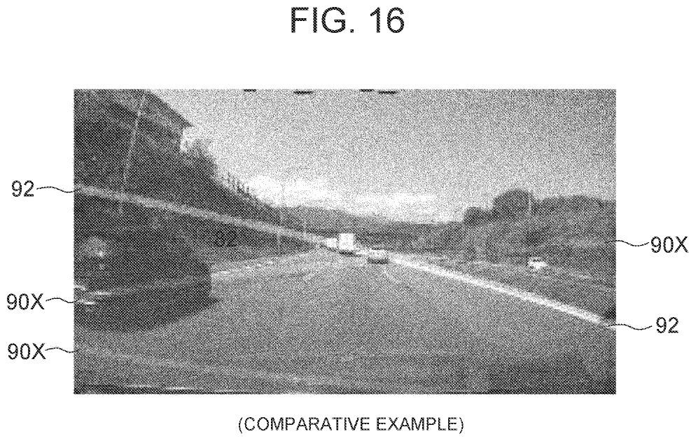

FIG. 15 shows an image resulting from superposing approximate curve lines in the comparative example on the image of the second lines in FIG. 13. FIG. 16 shows an image resulting from superposing the approximate curve lines in FIG. 15 on the image in FIG. 12.

In the comparative example, the fitting of an approximate curve line 90X is performed only to the second line 80 in FIG. 15, which is relatively short. Therefore, the curvature of the approximate curve line 90X is higher than the curvature of the approximate curve line 90, and the approximate curve line 90X does not pass through the second line 82. As seen from FIG. 15 and FIG. 16, the approximate curve line 90X deviates from the actual roadway edge line. Consequently, the road region is inexact.

On the other hand, in the embodiment, it is possible to improve the detection accuracy for the roadway edge lines while using approximate curve lines, and accordingly to improve the estimation accuracy for the road region. Because of the use of approximate curve lines, even on a curve road, it is possible to estimate the road region with a high accuracy.

The present disclosure has been described above based on the embodiments. The embodiments are just examples, and those skilled in the art understand that various modifications can be made by combinations of constituent elements and processes and that the modifications is included in the scope of the present disclosure.

In the first embodiment, the first derivation unit 30 derives the probability that the local region is the road, for all local regions overlapping with the road region. However, the first derivation unit 30 may derive the probability that the local region is the road, depending on the ratio of the road region in the local region, for only local regions that are of the local regions overlapping with the road region and for which the semantical label is the “road” or the “vehicle”. The first derivation unit 30 may set zero as the probability that the local region is the road, for the local regions other than the local regions that are of the local regions overlapping with the road region and for which the semantical label is the “road” or the “vehicle”. With this modification, it is possible to reduce processes.

The third embodiment and the first embodiment may be combined. That is, the first detection unit 12 may detect a plurality of lines on the road from one acquired image, may evaluate approximate straight lines of the plurality of detected lines, may evaluate one approximate curve line based on two lines giving two approximate straight lines when the slopes and intercepts of the two approximate straight lines satisfy the predetermined condition, may evaluate approximate curve lines of lines giving approximate straight lines that do not satisfy the predetermined condition, and may detect approximate curve lines that are of the evaluated approximate curve lines and that have the largest and smallest slopes, as the roadway edge lines.

The road obstacle detection device 1 does not need to be implemented by one device. The above functions may be shared by a plurality of different devices, and may be realized as the whole.

The use manner of the road obstacle detection device 1 is not particularly limited. For example, the road obstacle detection device 1 may be mounted on the vehicle, and may detect the road obstacle in real time, from an image photographed by an in-vehicle camera. Alternatively, the road obstacle detection device 1 may be implemented in a roadside unit or a server device on a cloud. The road obstacle detection process does not need to be performed in real time.

In the embodiments, the threshold process is performed to the probability (likelihood) that the road obstacle exists, and the rectangular region circumscribed around the road obstacle is evaluated and output. However, the processes do not always need to be performed. For example, the likelihood before the threshold process may be adopted as the final output.

What is claimed is:

1. A road obstacle detection device comprising:
an acquisition unit configured to acquire an image resulting from photographing a road;
a detection unit configured to detect roadway edge lines from the acquired image;
a road region estimation unit configured to estimate a road region in the image, based on the detected roadway edge lines;
a division unit configured to divide the acquired image into a plurality of local regions;
a first derivation unit configured to derive, for each of the plurality of local regions, a probability that the local region is the road, such that the probability is higher as a ratio of the road region in the local region is higher; and
a second derivation unit configured to derive a probability that a target local region is not a previously decided normal physical body, and to derive a probability that a road obstacle exists at the target local region, based on the derived probability that the target local region is not the normal physical body and a probability that a peripheral local region is the road, the peripheral local region being a local region at a periphery of the target local region, the probability that the peripheral local region is the road being derived by the first derivation unit.

2. The road obstacle detection device according to claim 1, further comprising a semantical label estimation unit configured to estimate a semantical label of each pixel of the acquired image, wherein
the first derivation unit derives a probability that a local region not overlapping with the road region is the road, based on a probability that the semantical label of each pixel of the local region not overlapping with the road region is the road.

3. The road obstacle detection device according to claim 1, wherein:
the detection unit detects a plurality of lines on the road from the acquired image, evaluates approximate lines of lines that are of the plurality of detected lines and that have lengths equal to or longer than a predetermined value, and detects approximate lines that are of the evaluated approximate lines and that have largest and smallest slopes, as the roadway edge lines; and
the road region estimation unit estimates that the road region is a region that is in the image and that is partitioned by the two detected roadway edge lines.

4. The road obstacle detection device according to claim 1, wherein:
the detection unit detects a plurality of lines on the road from the acquired image, evaluates approximate straight lines of the plurality of detected lines, evaluates one approximate curve line based on two lines giving two approximate straight lines when slopes and intercepts of the two approximate straight lines satisfy a predetermined condition, evaluates approximate curve lines of lines that do not satisfy the predetermined condition, and detects approximate curve lines that are of the evaluated approximate curve lines and that have largest and smallest slopes, as the roadway edge lines; and
the road region estimation unit estimates that the road region is a region that is in the image and that is partitioned by the two detected roadway edge lines.

5. The road obstacle detection device according to claim 1, wherein:
the acquisition unit acquires a plurality of time-series images; and
the detection unit detects first lines on the road from each of the plurality of acquired lines, and detects the roadway edge lines based on a plurality of second lines obtained by superimposing the detected first lines.

6. The road obstacle detection device according to claim 5, wherein:
the detection unit evaluates approximate lines of second lines that are of the plurality of second lines and that have lengths equal to or longer than a predetermined value, and detects approximate lines that are of the evaluated approximate lines and that have largest and smallest slopes, as the roadway edge lines; and
the road region estimation unit estimates that the road region is a region that is in the image and that is partitioned by the two detected roadway edge lines.

7. The road obstacle detection device according to claim 5, wherein:
the detection unit evaluates approximate straight lines of the plurality of second lines, evaluates one approximate curve line based on two second lines giving two approximate straight lines when slopes and intercepts of the two approximate straight lines satisfy a predetermined condition, evaluates approximate curve lines of second lines that do not satisfy the predetermined condition, and detects approximate curve lines that are of the evaluated approximate curve lines and that have largest and smallest slopes, as the roadway edge lines; and
the road region estimation unit estimates that the road region is a region that is in the image and that is partitioned by the two detected roadway edge lines.

8. A road obstacle detection method comprising:
an acquisition step of acquiring an image resulting from photographing a road;
a detection step of detecting roadway edge lines from the image acquired in the acquisition step;
an estimation step of estimating a road region in the image, based on the roadway edge lines detected in the detection step;
a division step of dividing the image acquired in the acquisition step, into a plurality of local regions;
a first derivation step of deriving, for each of the plurality of local regions, a probability that the local region is the road, such that the probability is higher as a ratio of the road region in the local region is higher; and
a second derivation step of deriving a probability that a target local region is not a previously decided normal physical body, and deriving a probability that a road obstacle exists at the target local region, based on the derived probability that the target local region is not the normal physical body and a probability that a peripheral local region is the road, the peripheral local region being a local region at a periphery of the target local region, the probability that the peripheral local region is the road being derived in the first derivation step.

9. A program that causes a computer to execute:
an acquisition step of acquiring an image resulting from photographing a road;
a detection step of detecting roadway edge lines from the image acquired in the acquisition step;
an estimation step of estimating a road region in the image, based on the roadway edge lines detected in the detection step;
a division step of dividing the image acquired in the acquisition step, into a plurality of local regions;
a first derivation step of deriving, for each of the plurality of local regions, a probability that the local region is the road, such that the probability is higher as a ratio of the road region in the local region is higher; and
a second derivation step of deriving a probability that a target local region is not a previously decided normal physical body, and deriving a probability that a road obstacle exists at the target local region, based on the derived probability that the target local region is not the normal physical body and a probability that a peripheral local region is the road, the peripheral local region being a local region at a periphery of the target local region, the probability that the peripheral local region is the road being derived in the first derivation step.
